(19) United States
(12) Patent Application Publication
(10) Pub. No.: US 2004/0019571 A1
(43) Pub. Date: Jan. 29, 2004

(54) Mobile communication device with electronic token repository and method

(75) Inventors: Roger A. Hurwitz, Portland, OR (US); Marion H. Shimoda, Aloha, OR (US); Rajesh P. Banginwar, Hillsboro, OR (US); Thomas M. Cronin, Hillsboro, OR (US); Travis T. Shultz, Hillsboro, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/205,970

(22) Filed: Jul. 26, 2002

(51) Int. Cl. G06F 17/60

(52) U.S. Cl. 705/65

(57) ABSTRACT

A mobile communication device includes a token repository for securely storing one or more tokens. The tokens are electronic or software objects that may represent, for example, coupons, tickets, electronic money, a membership card, an identification card, a doctor's appointment or a meeting. A token may be purchased from a token issuer or may be received for free. Tokens may be received automatically in accordance with a policy manger of the device. A token is checked-in over a secure communication link established with the token issuer. At the time of use, the token may be checked-out over a secure communication link established with a token processor. The device includes a communication interface to establish the secure communication links with token issuers and token processors in accordance with one or more wireless communication techniques. The device may also include a security processor to enforce and implement security requirements of checking in, storing and checking out tokens.

### TECHNICAL FIELD

The present invention pertains to electronic communications, and in particular, to mobile communication devices that store electronic tokens, and in one embodiment, to mobile communication devices that store electronic token representing tickets and coupons.

### BACKGROUND

Persons attending an event such as a concert, play, or sporting event typically purchase tickets in advance. Tickets are usually available at the venue's box office and through ticket distributors in coordination with the hosting venue and the event promoter. Tickets are also usually available through ticket outlets, ticket brokers, telephone sales, remote ticket printing applications, ticket kiosks and Internet web sites. Current ticket distribution systems rely on the paper upon which tickets are printed under the assumption that the ticket is very difficult to duplicate. Some conventional ticket distribution systems rely on a mail service to deliver the tickets. The ticket collectors visually verify the tickets'authenticity and then may physically alter the tickets to prevent their re-use. Because issued tickets have monetary value, there are many difficulties and risks associated with conventional tickets and conventional ticket distribution systems. Persons risk losing the tickets or having the tickets stolen and used by an unauthorized person. One problem with conventional tickets is that there is generally no connection between the individual purchasing the ticket and the ticket itself, allowing an unauthorized person to easily use a stolen ticket. Another problem with conventional tickets and conventional ticket distribution systems is that if an event is rescheduled or cancelled, tickets may have to be re-issued and the ticket holder is not easily notified. Another problem with conventional ticket distribution is that tickets may be lost in the mail. Electronic tickets have reduced some of these problems with conventional tickets and ticket distribution systems, but have created some additional burdens, such as waiting in line at the time of use to verify a person's identity.

In addition to tickets, many people also carry other items of monetary value, such as coupons, that are, for example, printed on paper. Coupons are good for many things including discounts and services and conventionally come in paper form. Like tickets, many coupons are generally not permitted to be reproduced. In addition to their risk of loss, one difficulty with conventional coupons and coupon distribution methods is that conventional coupons are difficult for persons to manage and keep track of. It's not uncommon for someone shopping in a grocery store to carry a large file of coupons and have to sort through them to determine what they are applicable to. In addition, it is especially burdensome and requires personal discipline to eliminate expired coupons from the file. Another problem with conventional coupons is that they are generally transferable allowing any holder to use the coupon. Another problem with conventional coupons is that complex coupons are difficult to implement. For example, a coupon that requires the purchase of one or more certain products to receive a third product at no cost is difficult to track and manage. Another problem with conventional coupons is that they are difficult to process quickly and generally do not provide any marketing information about the user. Further, the user generally retains no information regarding use of the coupon after its use. Another problem with conventional coupons is that once they are issued, they are difficult to revoke.

The disadvantages of conventional tickets and coupons, and conventional ticket and coupon distribution systems also apply to other items of monetary value including money itself. Money in the form of coins and paper is easily lost and once lost, may be used by any person.

### BRIEF DESCRIPTION OF THE DRAWINGS

The appended claims are directed to some of the various embodiments of the present invention. However, the detailed description presents a more complete understanding of the present invention when considered in connection with the figures, wherein like reference numbers refer to similar items throughout the figures and:

FIG. 1 is a functional block diagram illustrating an operational environment of an embodiment of the present invention;

FIG. 2 is a functional block diagram of a mobile communication device in accordance with an embodiment of the present invention;

FIG. 3 illustrates an example of a token in accordance with an embodiment of the present invention;

FIG. 4 is a flow chart of a token check-in procedure in accordance with an embodiment of the present invention; and

FIG. 5 is a flow chart of a token checkout procedure in accordance with an embodiment of the present invention.

### DETAILED DESCRIPTION

The following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents.

Many people today carry one or more mobile communication devices, such as a personal digital assistant (PDA), a laptop and portable computer with wireless or wireline communication capability, a web tablet, a wireless telephone, a pager, or an instant messaging device. Although these devices serve a primary purpose, many have (or are easily configured to have) memory and processing capabilities that allow such devices to serve other purposes. For example, it may be desirable for such devices to receive, store and provide, for example, tokens representing tickets and/or coupons in a secure manner reducing some of the disadvantages of conventional tickets and coupons, and conventional ticket and coupon distribution systems, as well reducing the risks of carrying other items that may have monetary value.

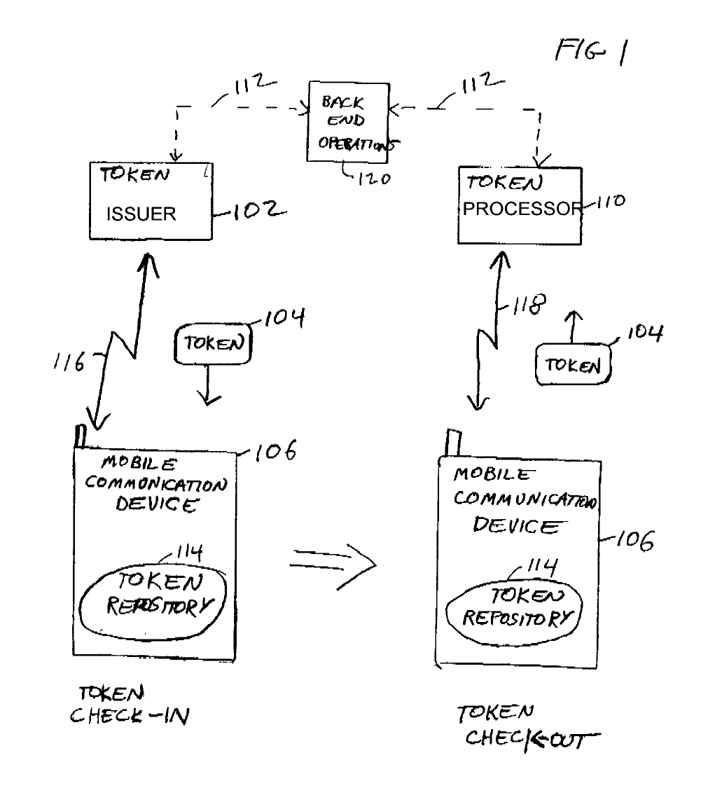

FIG. 1 is a functional block diagram illustrating an operational environment of an embodiment of the present invention. During token check-in, token issuer 102 provides token 104 to mobile communication device 106. One or more tokens 104 may be stored in token repository 114. During check-in, secure communication link 116 may be established between token issuer 102 and device 106. At checkout, device 106 may provide one of tokens 104 to token processor 110. During checkout, secure communication link 118 may be established between device 106 and token processor 110.

Token 104 may be an electronic or software object, and may have some monetary value. Token 104 may, for example, represent tickets, coupons, and/or electronic money. Tickets may include, for example, airline tickets, movie tickets, event tickets, and conference tickets. Coupons may be used for a product or service, for example. Coupons may be good for a predetermined number of items, such as for cups of coffee, for a percentage discount for purchases, or for receiving of a particular item or service. Coupons may be for particular stores or vendors or may be applicable to many stores or vendors. Electronic money may be suitable for mobile commerce (e.g., M-commerce) and point of sale (POS) transactions. Electronic money may take many forms including, for example, electronic travelers checks and gift certificates. Tokens 104 may also represent membership cards, identification cards, a doctor's appointment or meeting. Token 104 may be generally categorized as being in either an incremental-use class, a one time use class or unlimited use class. The incremental-use class includes tokens that are good for more than a one-time use and may include a counter that is decremented or incremented with each use. The one-time use class includes tokens that are good for only one use and are invalid after their use. The unlimited use class may allow for unlimited use of a token (e.g., a coupon that provides a percentage discount) and may have an expiration date. In one example, tokens in the one-time use class may be incremented when a user purchases a particular produce or service and may permit the token holder to receive a free product or service after a predetermined number of such product/service purchases.

Token 104 may also provide the functionality of membership cards and identification badges. In one embodiment, token 104 may include appointment related information for an appointment such as a doctor's appointment, an interview, or a meeting. In the case of a medical appointment, token 104 may include medical records, authorizations and approvals. In the case of an interview or meeting, token 104 may include location, direction, meeting or interview schedule, and other information pertinent to the interview or meeting.

Mobile communication device 106 may be a portable electronic communication device capable of wireless and/or wireline communications with third parties. By way of example, device 106 may be a personal digital assistant (PDA), a laptop and portable computer with wireless or wireline communication capability, a web tablet, a wireless telephone, a pager, an instant messaging device, an MP3 player, a digital camera or other devices that may receive and/or transmit information including a general purpose processing device.

Token issuer 102 may be a device configured to communicate with device 106. Token issuer 102 may be a terminal operated by a third party having the authority to issue tokens 104. Examples of such third parties may include ticket providers, coupon providers, banks and credit unions. Token processor 110 may be a device configured to receive a token 104 from device 106 and may be located where a token may be used. For example, token processor 110 may be located at an entrance to a sporting event for receipt of tokens that represent tickets for the event. Token processor 110 may also be located, for example, at a store that provides goods or services for accepting tokens that represent coupons. Token issuer 102 and token processor 110 may include, for example, a kiosk, computer terminal, ATM terminal, a cash register, or a mobile communication device. In one embodiment, token issuer 102 and token processor 110 may include POS terminals.

In one embodiment, token issuer 102 may be a computer terminal, such as the user's home or office computer that may communicate over a network, such as an intranet or the Internet, with entities that wish to issue token 104. For example, a user may access a Web site using a personal computer, complete a form, pay for a ticket and receive a token on the personal computer. The user may transfer the token from the personal computer to the user's device 106, such as a PDA. The user takes the PDA to the venue for which the ticket applies and at the venue, the user's PDA may be interrogated at the entrance permitting entrance to the event. The interrogation may include updating the token with date, time and entrance information. Update information related to the token, such as directions for getting to seat assignments, or schedule revisions, may also be made available to the user's PDA at this time.

In one embodiment, token issuer 102 and token processor 110 may be the same device or may be co-located. For example, a token may be purchased at a coffee shop from a token issuer. The token may be updated each time a user purchases a particular item or service (e.g., a cup of coffee) at which time a token processor updates token 104. After a certain number of purchases, the user may be entitled to a free item or service.

Communication links 116 and 118 may be any wireless or wireline communication link including a wireless local area network (WLAN) link or a personal area network (PAN) link. Examples of links 116 and 118 include a wireless communication link in accordance with a Bluetooth standard, an infrared data link which may be in accordance with the Infrared Data Association (IRDA) standard, a wireless communication link in accordance the IEEE 802.11a standard, the IEEE 802.11b standard, or the IEEE 802.11g standard, and a wireless communication link in accordance with a home-RF standard such as the Home-RF Working Group (HRFWG) standard. Device 106 may include hardware and software interfaces to provide communication capability over one or more of these links with token issuer 102 and token processor 110. In one embodiment, communication links 116 and 118 may operate over short distances (e.g., less than 100 feet) and may be substantially line-of-site communications. In this embodiment, token issuer 102 and token processor 110 should be in-proximity to device 106 for establishment of a communication link. Device 106 may communicate with other devices through, for example, peer-to-peer communications.

Token repository 114 is a storage location within device 106 for securely storing one or more tokens 104. Token repository may be a memory element including, for example, any form of random access memory (RAM), a disk or hard drive, or an optical storage device.

In addition to performing a primary function such as telecommunications, messaging, or computing that is normally associated with device 106, in accordance with embodiments of the present invention, device 106 may serve as a token repository. For example, device 106 may receive a token representing an admission ticket to an event and may provide the token upon entering the event. Device 106 may receive a token representing coupon that may be used, for example, when purchasing a product. In one embodiment, tokens that represent coupons may be automatically received by device 106 when permitted by a policy manager. For example, a token issuer may automatically wish to provide coupons for a store in a mall when the user carrying device 106 is in or nearby the mall.

In one embodiment, back-end operations 120 may be performed to coordinate the issuance and use of tokens as well as track issued tokens. One or more third parties, depending on how responsibilities have been allocated for issuing, using and tracking tokens, may provide back-end operations 120. Many different token issuers 102 and many different token processors 110 may communicate with each other and with back-end operations 120 over communication links 112. Communication links 112 represent any form of communication method. Back-end operations 120 may retain a record of all issued tokens and may indicate to token processors when, for example, to revoke a token. Back-end operations 120 may also provide token issuers 102 and token processors 110 with the authority and information required for the check-in and check-out of tokens as described herein.

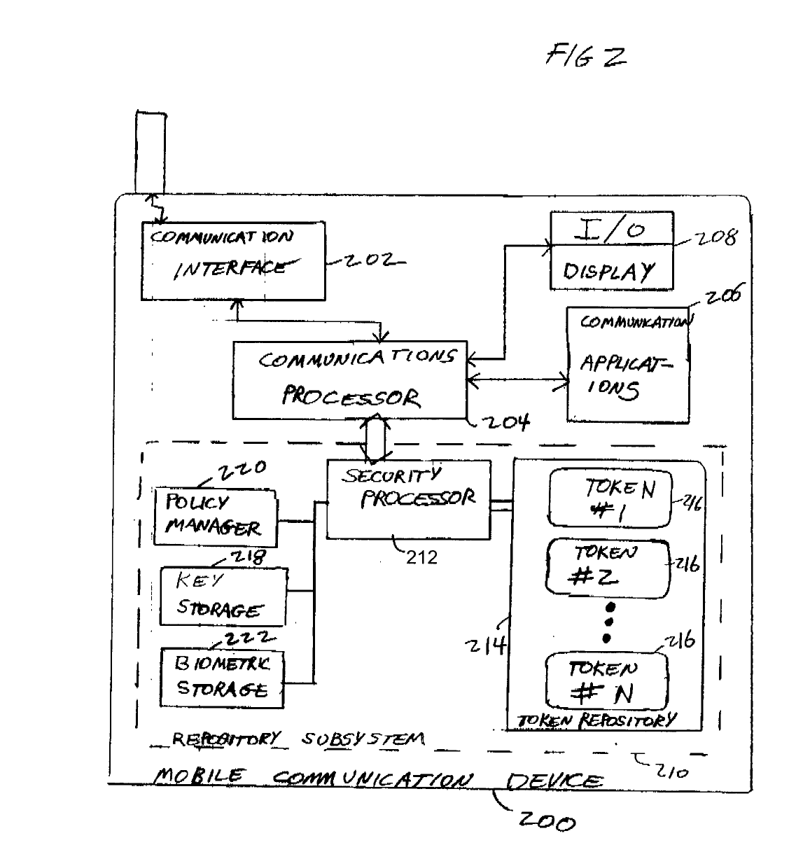

FIG. 2 is a functional block diagram of a mobile communication device in accordance with an embodiment of the present invention. Mobile communication device 200 may be suitable for use as device 106 (FIG. 1) although other devices are also suitable. Device 200 may receive a token during token check-in and allow for the use of a token during token checkout. Device 200 may include communication interface 202 to communicate with one or more communication networks (e.g., cellular telephone or wireless communication networks). Communication interface 202 may also communicate with token issuers and token processors as described herein. Device 200 also includes a communications processor 204 for implementing one or more communications applications 206 depending on the functionality of device 200. For example, device 200 may have PDA applications, instant messaging applications, and/or wireless phone applications. Device 200 may also include an I/O and display 208 for receiving user inputs and providing information to the user. The combination of communication interface 202, communications processor 204, applications 206 and display 208 permit device 200 to serve its primary purpose (e.g., to function as a PDA, a laptop and portable computer, a web tablet, a wireless telephone, a pager, an instant messaging device, an MP3 player, a digital camera or a general purpose processing device).

Device 200 also includes repository subsystem 210 for securely checking in and checking out tokens. Repository subsystem 210 may include security processor 212 for performing token check-in and check-out operations. Security processor 212 may also securely store tokens 216 in token repository 214 and securely access tokens 216 as stored therein. Token repository 214 may store many tokens 216, and in one embodiment, may store several hundred or more tokens therein. Token repository 214 is suitable as token repository 114 of device 106 (FIG. 1). Repository subsystem 210 may include key storage element 218 for storing security keys for use in token check-in and check-out operations. Repository subsystem 210 may also include biometric storage element 220 which may securely store personal identification numbers (PINs) and/or biometrics of one or more particular users authorized to check-in and check-out tokens using device 200. Repository subsystem 210 may also include policy manager 220 for implementing policy management settings for receipt and use of tokens 216. Policy manager 220 may permit, for example, automatic receipt of certain types of tokens, or may require user concurrence before acceptance of tokens. Policy manager 220 may also expire tokens, organize tokens, revoke tokens and provide password protection for tokens. In one embodiment, policy manager 220 may operate differently on tokens depending on a token's context, for example, depending on location and/or time/date that the token is issued or processed.

In one embodiment, token repository 214 may be located on a removable module (such as a smart card) to allow a user to use tokens stored in token repository 214 on different mobile communication devices. In this embodiment, policy management information, keys, PIN and biometrics may also be securely stored on such a removable module, and may permit transfer of tokens between devices. In one embodiment, token repository 214 may be accessible over a network, such as the Internet, allowing access by multiple devices. In another embodiment, tokens may be stored in a data-store accessible on a LAN. Token repository 214 may also be located on a memory card, such as a compact flash memory card, a hard drive or diskette.

Device 200 may discover other communication devices including token issuer 102 (FIG. 1) and token processor 110 (FIG. 1), through, for example, an ad-hoc discovery process. Communication interface 202 may be comprised of transceivers for providing communications in accordance with one or more various communication formats including wireless network physical layers that may include wireless local area network (WLAN) protocols and/or wireless personal area network (WPAN) protocols. For example, interface 202 may include a Bluetooth transceiver to provide digital communications in accordance with a Bluetooth standard. Interface 202 may also include transceivers to respectively provide digital communications in accordance the IEEE 802.11a standard, the IEEE 802.11b standard, and/or the IEEE 802.11g standard. Interface 202 may also include an infrared transceiver to support an infrared serial data link, which for example, may be in accordance with the Infrared Data Association (IrDA) standard. Interface 202 may also include a home-RF transceiver to provide a digital communication link in accordance with a Home-RF standard. Interface 202 may also include other wireless transceivers for providing wireless communications in accordance with other wireless connectivity protocols.

In one embodiment, communication interface 202 includes functional elements to communicate in accordance with many different communication techniques allowing communication device 200 to check-in a token from a token issuer whose communications are restricted to one particular communication technique, as well as allowing communication device 200 to check-out a token with a token processor whose communications may be restricted to another one particular communication technique, for example. This permits communications with different and/or incompatible token issuers and token processors.

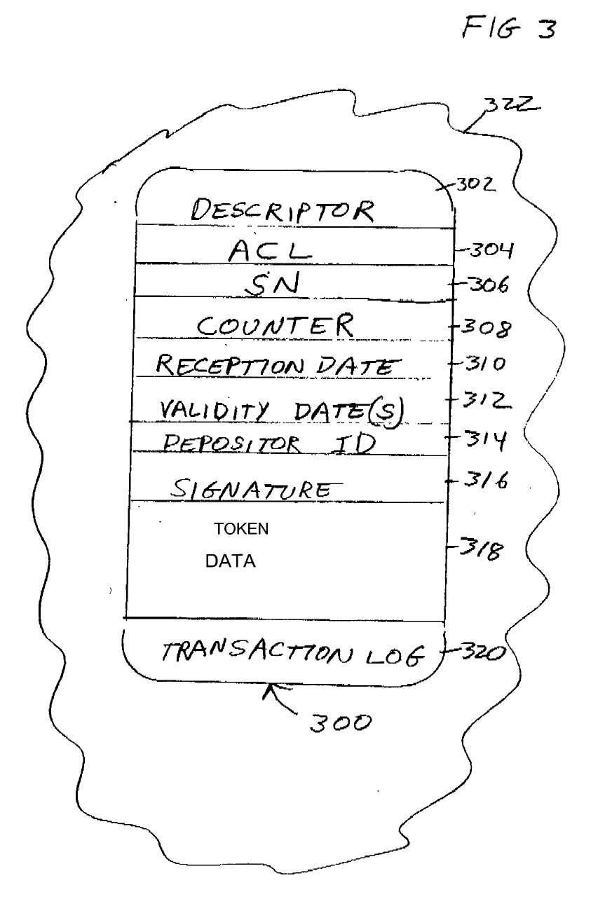

FIG. 3 illustrates an example of a token in accordance with an embodiment of the present invention. Token 300 may be suitable for use as token 104 (FIG. 1) although other tokens may be suitable. Token 300 may include descriptor field 302 indicating what the token represents. Descriptor field 302 may indicate that the token is a ticket, a coupon, or electronic money, and may indicate the class of the token. Descriptor field 302 may also include other details to help a user understand what the token represents. Token 300 may also include access control list (ACL) 304 which may list entities permitted to access the token, as well as the privileges associated with each entity. For example, ACL 304 may allow an entity to query whether a particular token exists, to read a field of the token, to read token data, to transfer the token, to update a token field, to update token data, and to invalidate the token.

Token 300 may also include field 306 for storing a number, such as a serial number, which may be used to uniquely identify the token from other tokens having the same description. Token 300 may also include counter field 308 for storing a value that may be incremented or decremented by the token processor during use of the token at checkout. In one embodiment, the entity authorized to perform the incrementing or decrementing of field 308 may be identified in ACL 304. Token 300 may also include reception date field 310 to indicate the date the token was created and received by the device. Token 300 may also include validity date field 312 to store validity dates for the token. In one embodiment, device 200 (FIG. 2) may automatically archive any tokens 216 that have expired. Token 300 may also include depositor identity (ID) field 314 to store an identity of the token issuer. For example, when the token represents a ticket to an event, the token issuer may be a ticket sales agency.

Token 300 may also include a signature field 316 to store, for example, one or more digital signatures. The digital signatures stored in field 316 may include one or more digital signatures of certain fields of the token to allow the system to determine if the token has been tampered with.

Token 300 may also include token data field 318 to store data relevant to the token. For example, token data field 318, in the case of a ticket, may include ticket information such as date, time, and place if applicable, the name of the event, who the ticket was issued to, and for how much. It may also include information such as how to get to the location of the event, how to get to parking near the event, etc. The vendor issuing the ticket may embed information of its choice into this field. For example, token data field 318, in the case of a coupon, may include information about the product(s) for which the coupon is valid, as well as the value of the coupon to the user. It may also include information about where the coupon was acquired, and where it may be or was used. For example, token data field 318, in the case of a membership card, may include information about where the card was issued, where it has been used, and for what, and where additional membership information can be found (e.g., on the Internet through an URL).

Token 300 may also include transaction log field 320 to store a record of any transactions involving token 300. For example, transaction log field 320 may include a record of each time the token is accessed by an entity on ACL 304. For certain tokens, transaction log field 320 may record information pertaining to each time field 308 is accessed. For example, transaction log field 320 may include records of changes made to the ACL, including information about who made the change, what the change was, and when it was made. The transaction log may include information about accesses to the token based on the token access control described by the ACL; the information may include who made the access, associated ACL entries, the access type, what was accessed, when the access was made, and other access-related information.

Each field of token 300 except for the token data field 318 may be of a defined format. Token data field 318 may be an opaque data type. In the case of the defined format fields, the token repository software may be able to manipulate the fields in well-defined ways. For example, it may construct a list of tokens of a particular type by interrogating the token type in the descriptor field of each token. In another example, the software may construct a list of currently valid tokens by interrogating the validity date field(s). In another example, the software may list all tokens associated with a specific depositor by interrogating the Depositor ID field of each token. In the case of the opaque data field, (e.g., token data 318) the information may be in a token-specific format. That information may be meant to be interpreted by software associated with the token itself. For instance, if it is a coupon token for a specific vendor's product, which is issued by a specific coupon servicing company, software from the coupon servicing company may be responsible for defining, storing and interpreting the token data 318. It may be up to that software to determine how, when, and what data in token data 318 field to expose to the user through a user interface. The token issuer, for example, may encrypt the token data field prior to token check-in. The encryption may be intended to prevent other entities from reading the token contents. In one embodiment of the present invention, token 300 may be wrapped with user security 322 when stored in a mobile communication device. User security 322, for example, may include secure storage of the token to prevent use by another user.

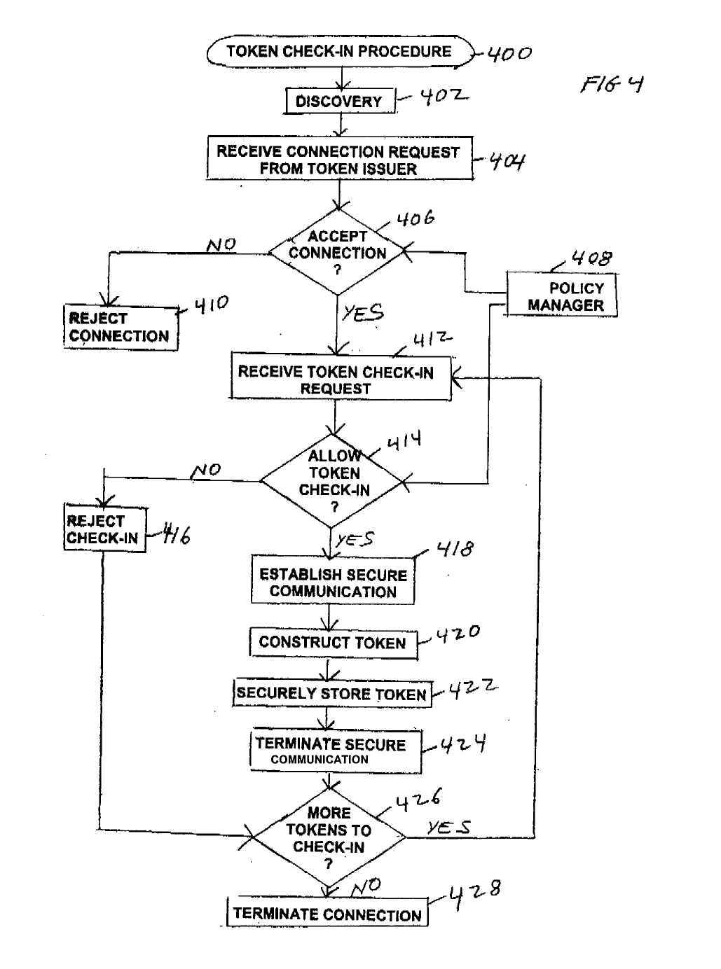

FIG. 4 is a flow chart of a token check-in procedure in accordance with an embodiment of the present invention. A mobile communication device, such as device 100 (FIG. 1) may perform procedure 400 although other devices are also suitable. A mobile communication device may implement procedure 400 to check-in one or more tokens for subsequent use. Although the individual operations of procedure 400 are illustrated and described as separate operations, one or more of the individual operations may be performed concurrently and nothing necessarily requires that the operations be performed in the order illustrated. In some embodiments however, some operations must be performed in a specific order.

Operation 402 performs discovery process in which the token issuer and mobile communication device (MCD) may automatically discover the presence of each other. As part of operation 402, the communication parameters of both parties (i.e., the token issuer and MCD having a token repository) may be identified to permit communications therebetween. Operation 402 may include an indication by the MCD that it is able to accept tokens (e.g., that contains a token repository “service”).

Once the two entities have discovered each other, operation 404 may be performed. In operation 404, the token issuer may initiate a connection with token repository service software on the MCD. In operation 406, either a user of the MCD or policy manager 408 on the MCD may determine whether or not to accept the token repository service connection with the token issuer. If the connection is not accepted in operation 406, operation 410 is performed in which the token check-in process may be aborted.

When the connection is accepted in operation 406, operation 412 is performed. In operation 412, a token check-in request is received from the token issuer. The token check-in request message may include a brief description of the token or may indicate a category of the token. The description of the token may also include a cost for receiving the token.

Operation 414 determines whether or not the mobile communication device desires to accept the token identified in the token check-in request message. Operation 414 may check with policy manager 408 of the device to determine when the user desires to automatically receive such a token. Operation 414 may also query the user to determine if the user desires to receive the token. In the later case, operation 414 may prompt the user with a sound and may display at least a portion of the description of the token or a token category for the user. The user may be asked to indicate whether he/she wishes to receive the token with, for example, a voice command or keyboard entry.

When it is determined in operation 414 not to accept the token check-in request, operation 416 is performed in which the token check-in request is rejected and a token rejection message may be sent to the token issuer.

When it is determined in operation 414 to accept the token check-in request, operation 418 is performed and a token acknowledgement message may be sent to the token issuer. The acknowledgement message may be sent over a communication link whose parameters were established during discovery operation 402. In operation 418, secure communication between the token issuer and the MCD may be established to transfer data associated with the token checkin transaction. Operation 418 may establish a secure communication link, such as link 116 (FIG. 1) between the token issuer and the device.

One purpose of the secure communication link is to prevent use and/or access of the token by an unauthorized third party that may intercept the communications. Any of several secure communication set-up procedures may be used to establish the secure communication link. The secure communication link may provide for packet encryption as well as authentication, may use asymmetric and/or symmetric cryptographic techniques, and may utilize one or more keys stored within the device. For example, a secure-socket layer (SSL) or key exchange procedure may be implemented as part of operation 418. In one embodiment, the user of the mobile communication device may be required to authenticate him or her self by providing a biometric or PIN. For example, the user's voice may be authenticated through a speaker verification process, or the user may provide a fingerprint for verification.

Operation 418 may include authenticating the token issuer, which may include one or more authentication techniques including verification of a digital signature of the token issuer. In this case, the mobile communication device may use a public key of the token issuer to verify the digital signature. In one embodiment, operation 418 may include sending a form of payment to the token issuer. A credit card number or bank account number may be sent to the token issuer authorizing payment for the token. In one embodiment, the user may be asked to verify the amount of payment as part of operation 418. The payment information may be securely stored within the mobile communication device. In one embodiment, operation 418 may include receiving an electronic receipt for the payment.

In operation 420, the token is constructed. As part of operation 420, the token issuer and MCD may engage in transactions resulting in the construction of a token. Certain fields of the token may be secured with some form of security depending on the type of token and anticipated use of the token. For example, the entire token and/or particular fields of the token may be digitally signed (e.g., with a key of the token issuer) to prevent tampering. Other particular fields may be concealed, for example, with encryption. Token 300 (FIG. 3) is an example of a suitable token, although other tokens are also suitable.

In operation 422, the MCD securely stores the token. Operation 422 may securely store the token within a token repository, such as repository 214 (FIG. 2) of the device. Operation 422 may involve adding additional security to the token by a security processor such as security processor 212 (FIG. 2). For example, access and use of the token may be restricted to authorized users which may be defined, for example, in an access control list field of the token. The token may be encrypted by the user's encryption key. In one embodiment, when the token is stored, operation 422 may include updating the token's transaction log to indicate the date and time of receipt of the token. Once the token is checked-in, operation 424 may terminate the secure communication link established in operation 418.

After the secure communication link has been terminated in operation 424, or the token check-in request was rejected in operation 416, operation 426 may be performed. Operation 426 determines if the token issuer has more tokens to be checked in. When operation 426 determines that there are no more tokens to be checked in, operation 428 may terminate the connection established in operation 406, and the token-check in procedure is complete.

When operation 426 determines that there are more tokens to be checked in, (e.g., the token issuer has more tokens for the MCD) operations 412 through 424 may be repeated for another token until all tokens are checked in.

In one embodiment, all or portions of procedure 400 may be performed automatically without substantial intervention by the user. In this embodiment, the cost of the token may have been presented to the user as part of operation 414. Alternatively, the user of the device may provide payment to the token issuer by a way external to the device. For example, the user may pay cash or provide a credit card directly to the token issuer. In one embodiment, the token issuer may be accessed over the Internet by a computer in communication with the device. In this embodiment, the user may input payment information into the computer. In this embodiment, the token providing device may be the user's home computer operating in-proximity to the device. In some situations, there may be no cost associated with receipt of the token (e.g., free coupons or free tickets).

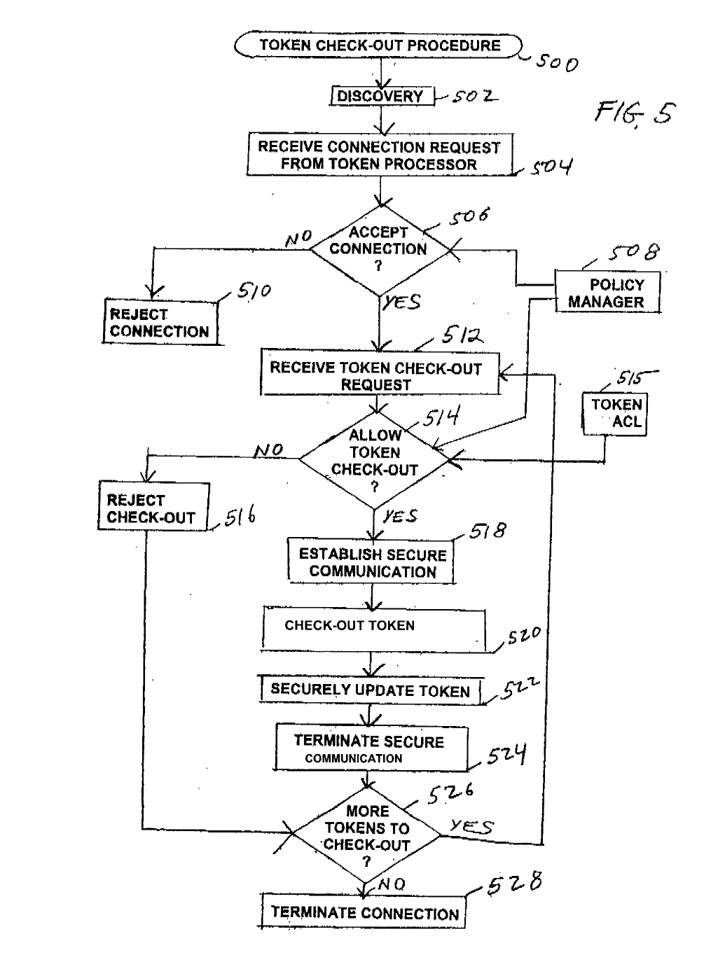

FIG. 5 is a flow chart of a token check-out procedure in accordance with an embodiment of the present invention. A mobile communication device, such as device 200 (FIG. 2) may perform procedure 500 although other devices are also suitable. Procedure 500 may be implemented between a mobile communication device and token processor to check-out a token at time of use. Token check-out includes any use of a token including updating tokens in the incremental-use class. Although the individual operations of procedure 500 are illustrated and described as separate operations, one or more of the individual operations may be performed concurrently and nothing necessarily requires that the operations be performed in the order illustrated. In some embodiments however, some operations must be performed in a specific order.

Operation 502 performs discovery process in which the token processor and mobile communication device (MCD) may automatically discover the presence of each other. As part of operation 502, the communication parameters of both parties (i.e., the token processor and MCD having a token repository) may be identified to permit communications therebetween. Operation 502 may include an indication by the MCD that it contains a token repository “service” and is able to check out tokens.

Once the two entities have discovered each other, operation 504 may be performed. In operation 504, the token processor may initiate a connection with token repository service software on the MCD. In operation 506, either a user of the MCD or policy manager 508 on the MCD may determine whether or not to accept the token repository service connection with the token processor for token check-out. If the connection is not accepted in operation 506, operation 510 is performed in which the token check-out process may be aborted.

When the connection for token check-out is accepted in operation 506, operation 512 is performed. In operation 512, a token check-out request is received from the token processor. In one embodiment, the token check-out request message may identify the particular token.

Operation 514 determines whether or not the mobile communication device will allow check out of a particular token by the token processor. In one embodiment, operation 514 includes the token processor and MCD performing transactions to identify, which token the token processor, would like to check out. Operation 514 may check with policy manager 508 of the device to determine when the user desires to automatically check-out such a token. Operation 514 may also query the user to determine if the user desires to check-out the token. In the later case, operation 514 may prompt the user with a sound and may display at least a portion of the description of the token or a token category for the user. The user may be asked to indicate whether he/she wishes the token processor to checkout the token.

As part of operation 514, the token repository service may use the token's ACL 515 to determine which functions and/or privileges the token processor is allowed to perform. For example, depending on the class of the token, a token processor may only be allowed to read the token, to verify the token's presence, to decrement/increment a counter in the token, and/or to delete or invalidate the token.

When it is determined in operation 514 not to accept the token check-out request, operation 516 is performed in which the token check-out request is rejected and a token check-out rejection message may be sent to the token processor.

When it is determined in operation 514 to accept the token check-out request, operation 518 is performed and a token check-out request acknowledgement message may be sent to the token processor. The acknowledgement message may be sent over a communication link whose parameters were established during discovery operation 502. In operation 518, secure communication between the token processor and the MCD may be established to transfer data associated with the token check-out transaction. Operation 518 may establish a secure communication link, such as link 116 (FIG. 1) between the token processor and the device. Operation 518 may also include authenticating the token processor.

After the secure communication link is established in operation 518, the token check-out request is performed in operation 520. As part of operation 520, the token processor may engage in transactions. Operation 520 may also include updating the transaction log of the token. For each transaction, a transaction log entry may be added to the token. As appropriate, depending on the token checkout transaction initiated by the token processor, token related information may be returned from the MCD token repository service to the token processor.

In operation 522, the MCD securely updates the token based on the transactions of operation 520. Operation 522 may securely update the token within a token repository, such as repository 214 (FIG. 2) of the device. In one embodiment, when the token is stored, operation 522 may include updating the token's transaction log to indicate the date and time of check-out of the token. Once the token is checked-out, operation 524 may terminate the secure communication link established in operation 518.

After the secure communication link has been terminated in operation 524, or the token check-out request was rejected in operation 516, operation 526 may be performed. Operation 526 determines if the token processor has more token check-out requests. When operation 526 determines that there are no more token check-out requests, operation 528 may terminate the connection established in operation 506, and the token check-out procedure is complete.

When operation 526 determines that there are more token check-out requests, (e.g., the token processor desires to check out additional tokens from the MCD) operations 512 through 524 may be repeated for another token until all tokens are checked out.

After the performance of operation 528, the user of the mobile communication device may receive value for the checking out of the token. For example, the user may receive a product or service for the token. For example, when the token represents a coupon, the user may receive the value for what the coupon was for. For example, when the token represents an admission ticket, the user may be admitted to the event.

In one embodiment, all or portions of procedure 500 may be performed automatically without substantial intervention by the user. In one embodiment, most or all of procedure 500 may be performed automatically allowing a user to simply carry his or her mobile communication device and automatically check-out the token. For example, in the case of a token representing a ticket, a user may carry the device through an entrance of an event and be checked through automatically. For example, in the case of a token representing a coupon, the user may carry the device through a check-out line and the coupon may be used automatically.

In one embodiment, the user of the MCD may be authenticated prior to token check-out. In this embodiment, when the token processor or user desires to check-out the token, operation 514 may receive a biometric or PIN to authenticate the user of the device. In another embodiment, the token processor may be authenticated. In this embodiment, operation 514 may include verifying the identity of the token processor with any one or more authentication methods including the use of digital signature. Operation 514 may, for example, include verifying that the token processor is on ACL 515 of the token.

The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the invention embraces all such alternatives, modifications, equivalents and variations as fall within the spirit and broad scope of the appended claims.

What is claimed is:

1. The method for electronic token communication comprising:
establishing a first secure communication link with a token issuer to receive a token, the token being an electronic object;
securely storing the token in a mobile communication device; and
establishing a second secure communication link with a token processor to collect information from the token or deposit information to the token.

2. The method of claim 1 further comprising:
receiving a token check-in request message from the token issuer requesting whether the mobile communication device desires to receive the token, the mobile request message including a description of the token; and
responding to the token check-in request message to indicate whether the mobile communication device desires to receive the token.

3. The method of claim 2 wherein responding includes determining whether a policy manager of the mobile communication device permits the mobile communication device to automatically receive the token based on the description, and automatically sending a response to the token issuer to indicate that the mobile communication device will accept the token when the policy manager permits the automatic receipt of the token.

4. The method of claim 2 wherein responding includes prompting a user of the mobile communication device to indicate whether the user desires to receive the token, the prompting including displaying at least a portion of the description of the token.

5. The method of claim 1 further comprising:
authenticating an identity of the token issuer;
providing payment to the token issuer for the token over the first secure communication link; and
receiving the token over the secure communication link.

6. The method of claim 1 wherein the token processor provides either a product or service to a user in response to collection of information from the token.

7. The method of claim 1 further comprising:
receiving a token check-out message from the token processor requesting whether the user of the mobile communication device desires to check-out the token; and
responding to the token check-out message to indicate whether the user of the mobile communication device desires to use the token.

8. The message of claim 1 further comprising
authenticating an identity of the token processor;
prior to establishing the second secure communication link, prompting a user of the mobile communication device to provide a biometric; and
allowing access to the token by the token processor when the identity of the token processor is authenticated and when the biometric authenticates the user.

9. The method of claim 8 further comprising:
removing security from the token; and
sending the token to the token processor over the second secure communication link.

10. A mobile communication device comprising:
a token repository to securely store a token, the token being an electronic object; and
a security processor to provide first secure communications with a token issuer for receiving the token and to provide second secure communications with a token processor for either collection of information from or deposit of information to the token.

11. The device of claim 10 wherein the at least one token represents either a ticket or a coupon, and the device further comprises a communications interface to communicate over a first secure communication link with the token issuer, the first secure communication link established by the security processor.

12. The device of claim 11 wherein the communication interface communicates over a second secure communication link with the token processor for checking-out the token, the second secure communication link being established by the security processor, wherein the token processor provides either a product or service to a user in response to receipt of information collected from the token.

13. The device of claim 10 further comprising a policy manager to permit the device to automatically receive the token based on a description of the token without user intervention.

14. The device of claim 12 further comprising a biometric storage element to store biometric data for a user of the device, wherein the security processor authenticates the user prior to establishing the second secure communication link.

15. The device of claim 12 further comprising a key storage element to store a security key for use in establishing the first and second secure communication links.

16. A processing system comprising:
a security processor to establish a first secure communication link with a token issuer to receive a token, and to establish a second secure communication link with a token processor for use of the token, the token being an electronic object; and
a token repository to securely store the token.

17. The system of claim 16 further comprising a communications processor to receive a token check-in request message from the token issuer requesting whether a mobile communication device desires to receive the token, the mobile request message including a description of the token,
wherein the communications processor responds to the token check-in request message to indicate whether the user of the mobile communication device desires to receive the token.

18. The system of claim 16 further comprising a policy manager to permit the mobile communication device to automatically receive the token based on a description of the token, and to automatically send a response to the token issuer to indicate that the mobile communication device will accept the token.

19. The system of claim 16 wherein the security processor prompts the user to indicate whether the user desires to receive the token and displays at least a portion of the description of the token.

20. The system of claim 16 wherein the security processor authenticates an identity of the token issuer, provides payment to the token issuer for the token over the first secure communication link, and receives the token over the secure communication link.

21. The system of claim 16 wherein the token processor either collects information from the token or deposits information to the token over the second secure communication link after allowance of a token check-out request by the token processor.

22. The system of claim 16 wherein the token processor provides either a product or service to a user in response to collection of information from the token.
